(19) United States
(12) Patent Application Publication
(10) Pub. No.: US 2014/0062078 A1
(43) Pub. Date: Mar. 6, 2014

(54) PIPE CONNECTOR APPARATUS

(71) Applicant: Eric Weissmann, San Juan Capistrano, CA (US)

(72) Inventor: Eric Weissmann, San Juan Capistrano, CA (US)

(21) Appl. No.: 13/602,309

(22) Filed: Sep. 3, 2012

(51) Int. Cl. F16L 55/163; F16L 35/00

(52) U.S. Cl. 285/80; 285/328

(57) ABSTRACT

An apparatus is disclosed for connecting pipe sections of a pipe fitting or pipe. The apparatus includes a housing comprising a first and second inlets for receiving a piping section, a first and second O-ring internally disposed within recesses, a first and a second inlet disposed on the housing and configured to open into an interior region of the apparatus, wherein the second inlet may be disposed 180-degrees from the first inlet, and an integrally formed push-fit connection assembly comprising a teeth ring having a plurality of teeth directed generally radially inwardly and generally toward the interior region.

### TECHNICAL FIELD

This disclosure relates to pipe connections, and more particularly to connecting pipes by push-fitting.

### BACKGROUND

The statements in this section merely provide background information related to the present disclosure and may not constitute prior art.

Fittings or connectors for the connection of sections of pipes are known in a number of design types. Perhaps the simplest form of pipe connector is a sleeve for connecting two pipes together. The sleeve may fit around an end of each pipe and be sealed in position to effectively make the two pipes one. This type of connection fitting is often practiced in domestic plumbing, where the sleeve is usually formed of copper and soldered onto copper pipes.

More complex connectors tend to rely on some kind of compression fit. For example, a sleeve may be fitted onto the end of a pipe that squeezes around the outside of the pipe to form a seal. Often, a sealing component, such as an O-ring seal, is provided between the pipe and the sleeve. This type of seal is used in some more modern domestic plumbing systems and is often referred to as a “press-fit” or “push-fit” connector. In known push-fit type connectors typically a mechanical locking element ensures that a pipe section maintains a position with respect to the pipe to which it is joined. It is desirable to prevent the pipe from changing its position, which may occur due to rotational or lateral movement relative of the pipe section due to internal or external forces, to prevent the pipe from decoupling.

It can be appreciated that certain stresses and forces act upon the fitting during use. Certain types of pipe may also inherently shrink and expand under environmental conditions. In particular, if a connector is fitted to a pipe that subsequently expands the stress the connector applies to the pipe will increase, which may lead to the seal between the connector and pipe breaking or the pipe distorting around the O-ring. These connectors also tend to have multiple additional components, which can make them prone to break or wear out.

Therefore, there exists a need to increase the durability of the connection seal in a push-fit pipe connector.

### SUMMARY

An apparatus is disclosed for connecting pipe sections of a pipe fitting or pipe. The apparatus includes a housing comprising a first and second inlets for receiving a piping section, a first and second O-ring internally disposed within recesses, a first and a second inlet disposed on the housing and configured to open into an interior region of the apparatus, wherein the second inlet may be disposed 180-degrees from the first inlet. In one embodiment a push-fit connection assembly comprising a teeth ring having a plurality of teeth directed generally radially inwardly and generally toward the interior region is used to couple a piping section to the apparatus. A further embodiment of the apparatus including a pipe engaging section configured to crimp into a piping section thereby coupling the piping section to the apparatus. The interior region opens at least partially to at least one O-ring and is configured to accept a sealant through the first or second inlet that seals the O-ring to the apparatus and the piping section when applied.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 shows a side view of a pipe connector, in accordance with the present disclosure;

FIG. 2 shows a side view of a pipe connector connecting a first and second piping section, in accordance with the present disclosure;

FIG. 3 shows a cross-sectional view of a pipe connector, in accordance with the present disclosure;

FIG. 4 shows a cross-sectional view of an additional embodiment of the pipe connector, in accordance with the present disclosure;

FIG. 5 shows a cross-sectional view of an embodiment of the pipe connector with pipe sections connected, in accordance with the present disclosure;

FIG. 6 shows a cross-sectional view of an embodiment of the pipe connector depicting a further embodiment of a pipe connection means, in accordance with the present disclosure; and

FIG. 7 shows a cross-sectional view of an embodiment of the pipe connector depicted in FIG. 6 with the connection means engaging a pipe, in accordance with the present disclosure.

### DETAILED DESCRIPTION

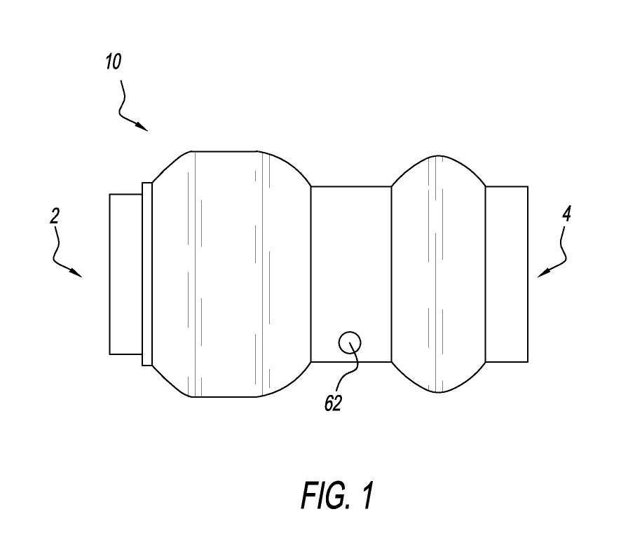

Referring now to the drawings, wherein the depictions are for the purpose of illustrating certain exemplary embodiments only and not for the purpose of limiting the same, FIG. 1 shows a side view of a pipe connector 10. The pipe connector 10 includes first and second receiving ends 2 and 4, respectively. The receiving ends may be adapted to receive various pipes and fittings and the disclosure herein is therefore not intended to be limited thereby. In one embodiment, the receiving ends may be threaded. Although in the preferred embodiment, the first end 2 is configured to receive a pipe or fitting having the same outside diameter as the second end 4, the pipe connector 10 may be configured to receive different sized pipes as will be readily apparent to one skilled in the art.

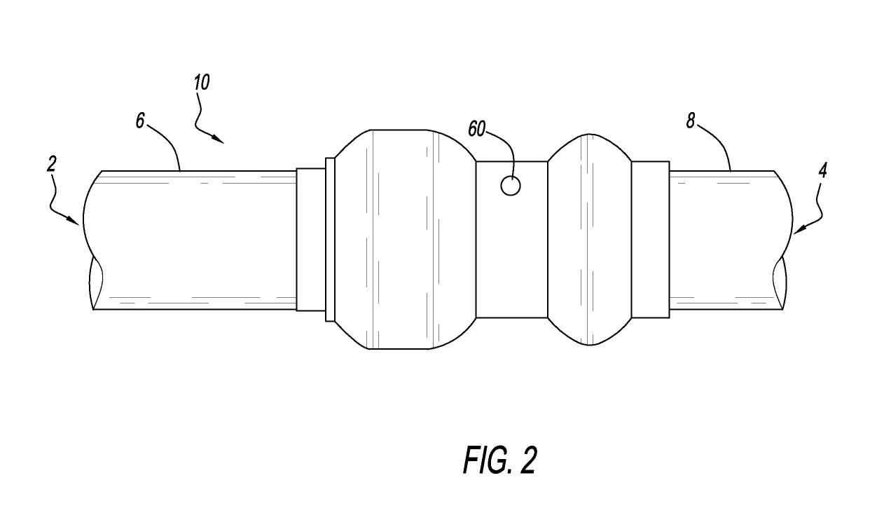

FIG. 2 shows a side view of a pipe connector 10 connecting a first and second piping section 6 and 8, respectively. In the preferred embodiment, the pipe connector 10 is formed of metal and is intended to receive copper piping, although other materials may be used for the pipe connector 10 and for the piping or other fittings to be connected. For example, the piping received by the at least one inlet and outlet of the pipe connector 10 are preferably copper, but may also be CTS, PVC or CPVC. The pipe connector 10 may also be used with pipe or tubing of polybutylene or PeX (cross-linked polyethylene) but the use of PeX tubing may require the use of an adapter which is provided within the PeX tubing to stiffen the end of the PeX tubing received by the pipe connector 10. The adapter comprises an annular ring which has an outside diameter corresponding to the inside diameter of the uncompressed PeX tubing. The adapter prevents the PeX tubing from being unduly compressed by teeth of the press-fit connection arrangement.

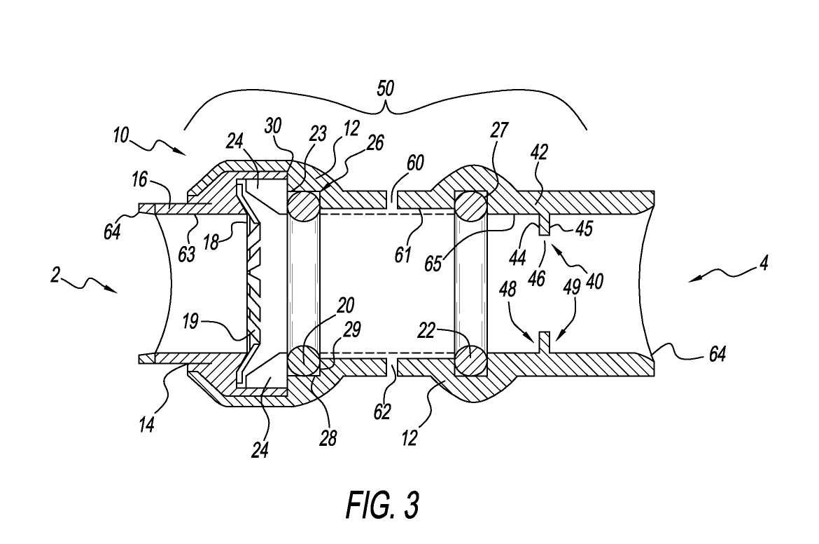

FIG. 3 shows a cross-sectional view of the pipe connector 10. The pipe connector 10 includes a push-fit connection arrangement 50 having a first component 12 and a second component 14, which are generally cylindrical in shape. The second component 14 is preferably threaded into the first component 12, however, various known coupling processes may be applied and the disclosure herein is therefore not intended to be limited thereby. The receiving ends 2 and 4 of the pipe connector 10 which are positioned axially preferably have tapered ends 64 so as to facilitate insertion of a pipe end or fitting into the pipe connector 10. In this way, the tapered ends 64 act as a guide to direct the pipe end or fitting into the pipe connector 10.

The second component 14 may include a release collar 16 configured to selectively engage a piping engaging member 18, i.e., a teeth ring or a split grab-ring. The release collar 16 is in coaxial alignment with the piping engaging member 18. The second component 14 may have an inner diameter which is slightly larger than an outside diameter of the pipe or fitting to be received. The second component 14 is preferably formed as to be threaded into the first component 12 to maintain the piping engaging member 18 in position on an annular shoulder 30.

The piping engaging member 18 includes a plurality of individual teeth 19 pointed generally inwardly toward first and second sealing members 20 and 22, respectively. In the preferred embodiment, the sealing members are O-rings but other suitable sealing members could be used in place of the O-ring. For example, an annular lip seal, or gasket. The teeth 19 have a generally flat end so as to securely grip an outer surface of a pipe or fitting without piercing or damaging the outer pipe surface. The piping engaging member 18 is preferably formed of spring steel but other materials may be used for the piping engaging member 18 depending upon the composition of the pipe or other fitting to be received by the piping engaging member 18. The piping engaging member 18 is directed radially inwardly and toward the first and second O-rings 20 and 22 preferably forming a series of generally V-shaped segments so as to form the individual teeth 19. A sealant may be applied to the piping engaging member 18 and interior surface areas of the second component 14 to permanently affix the piping engaging member 18 within the pipe connector 10.

The first component 12 includes a shoulder 30 that abuts an outermost portion of the second component 14 and thereby limits the position of the second component 14 relative to the piping engaging member 18. In this way, the second component 14 creates a receiving space for the piping engaging member 18. In addition, the portion of the second component 14 that abuts the first component 12 has a corresponding cross section so as to direct the teeth radially inwardly and generally toward the O-rings 20 and 22. The axially innermost portion of the second component 14 also prevents the teeth 19 from bending away from the O-rings 20 and 22, i.e., if the pipe or fitting is being pulled out of the pipe connector 10. The shoulder 30 is further adapted to receive an O-ring protector component 24, axially positioned within the second component 14 to abut the first O-ring 20. The O-ring protector 24 is configured to hold the first O-ring 20 in position within an O-ring shoulder 26.

The O-ring shoulder 26 has a diameter along an axial surface 28 which is slightly less than the cross-sectional diameter of the O-ring 20 so that the O-ring 20 will be compressed when the pipe or fitting is received within the pipe connector 10. The O-ring shoulder 26 also has an annular, radial surface 29 which has a width which is slightly less than the diameter of the O-ring 20 again so that the O-ring 20 is compressed when the pipe connector 10 receives the pipe or fitting. The shoulder 26 and the O-ring protector component 24 form a recess 23 for containing the first O-ring 20. A second recess 27 is formed to contain the second O-ring 22.

A pipe stop 40 is formed to position a first pipe and a second pipe within the pipe connector 10. The pipe stop 40 forms a first and second piping shoulder 48 and 49, respectively, to receive the first and second pipes or pipe fittings. The piping shoulders 48 and 49 have a diameter along an axial surface 42 which corresponds to and is slightly larger than an outside diameter of a pipe or tubing to be connected to the pipe connector 10. The first piping shoulder 48 has an annular, radial surface 44 which limits axial movement of the pipe or tubing when engaged by the pipe connector 10. The second piping shoulder 49 has an annular, radial surface 45 which limits axial movement of the pipe or tubing when engaged by the pipe connector 10. The pipe stop 40 is preferably a protrusion defined by the radial surfaces 44 and 45 and a top surface 46. The top surface 46 preferably protrudes at least as a width of an inserted pipe and is preferably flush with an interior surface thereof. For example, the pipe stop 40 is configured to receive a pipe or fitting having the same inside diameter as the top surface 46 and preferably the same annular-shape.

Between the O-rings 20 and 22, first and second holes, i.e., inlets 60 and 62, respectively, are disposed from a surface of the pipe connector 10 to the interior. The first inlet 60 is preferably larger than the second inlet 62. The first and second inlets 60 and 62 are configured to enable a user to insert a sealant suitable as a pipe adhesive such as an epoxy into the pipe connector 10 as described herein below. In one preferred embodiment, the first inlet 60 is configured to receive the sealant, while the second inlet 62 is configured to view the sealant within the pipe connector 10. To enable a user to view the epoxy, but inhibit sealant from exiting the pipe connector 10, the second inlet 62 is preferably configured with a smaller opening than the inlet size of the first inlet 60. In one embodiment, the size of the second inlet 62 may be adapted for a particular sealant to advantageously apply surface tension properties, i.e., the opening is configured to be large enough to view the sealant, but configured size constrained to inhibit leakage.

Interior walls of the pipe connector 10 are sized to receive piping and fitting. The pipe connector 10 has an interior diameter along an axial surface 63 and 65 to correspond to an exterior diameter of a pipe or fitting. A second axial surface 61 includes a diameter formed to create a space or cavity between the pipe or fitting section and the second axial surface 61. The diameter of the second axial surface 61 is preferably greater than the diameter associated with the axial surfaces 63 and 65. In this way, a user may inject sealant through the opening 60 and into a cavity space as described herein below.

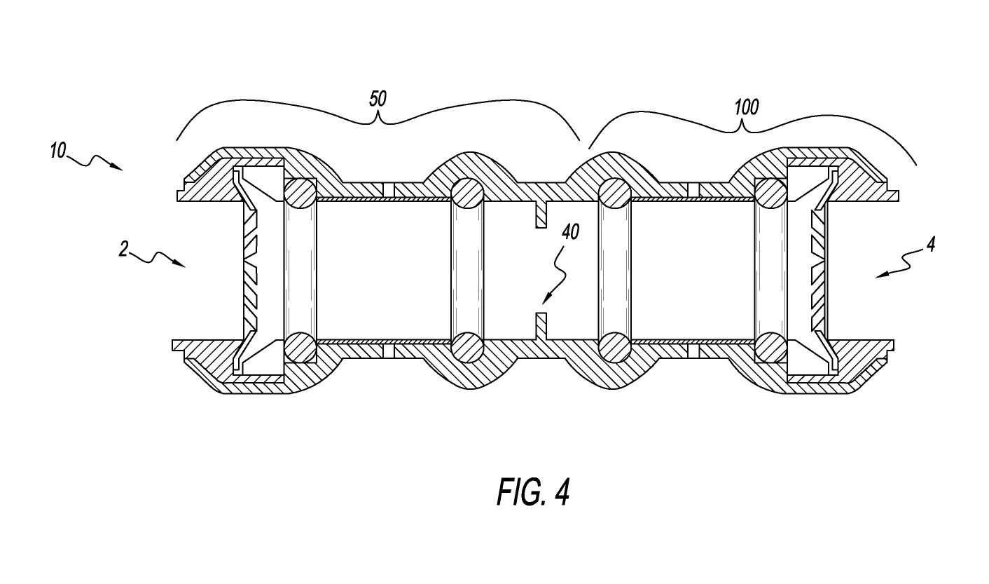

FIG. 4 shows a cross-sectional view of an additional embodiment of the pipe connector 10 having a second push-fit connection arrangement 100. The second push-fit connection arrangement 100 is a mirror structure of the first push-fit connection arrangement 50 described herein above. The second push-fit connection arrangement 100 is configured to receive a second piping section and engage the piping section in a push-fit type coupling. As described herein above, the pipe stop 40 is configured to abut the pipe or pipe fittings within the pipe connector 10. As FIG. 4 shows, the pipe stop 40 will abut inserted pipes or pipe fittings upon the first push-fit connection arrangement 50 receiving a first piping component and the second push-fit connection arrangement 100 receiving a second piping component.

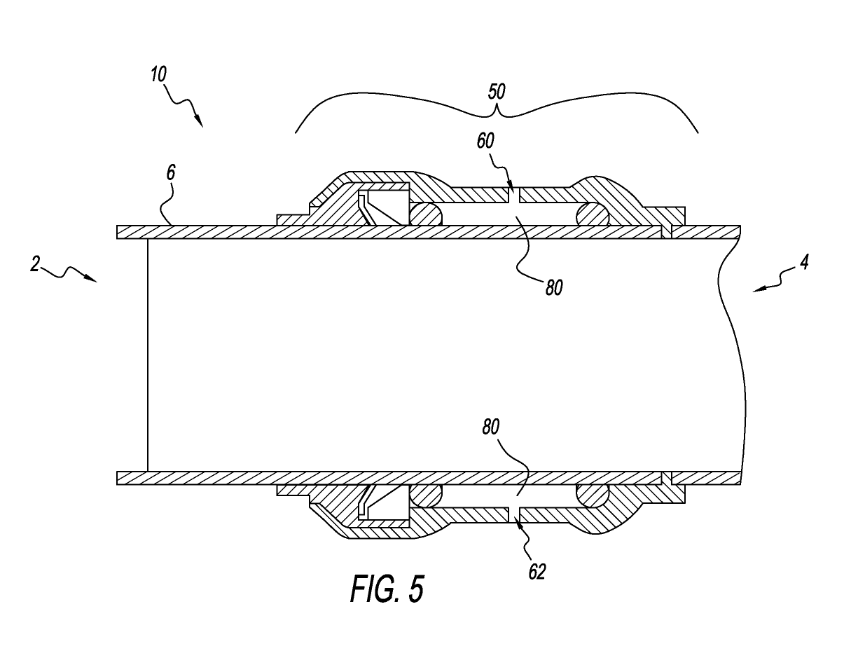

FIG. 5 shows a cross-sectional view of an embodiment of the pipe connector 10 with the exemplary piping section 6 and 8 connected therein. As FIG. 5 shows, an exemplary piping section 6 is inserted into the first end 2 of the pipe connector 10 and the second piping section 8 is inserted into the second end 4. The O-rings 20 and 22 are compressed when receiving the piping section 6. The first piping section 6 is engaged by the first push-fit connection arrangement 50 as described herein above. Subsequent to insertion of the first piping section 6, a user may inject a sealant 80 into the pipe connector 10. The sealant 80 flows around the piping section 6 into the recesses 23 and 27 of the first and second O-rings 20 and 22. In this way, the sealant fortifies the fitting of the piping section 6 against the O-rings 20 and 22 creating a more durable and long-lasting fit.

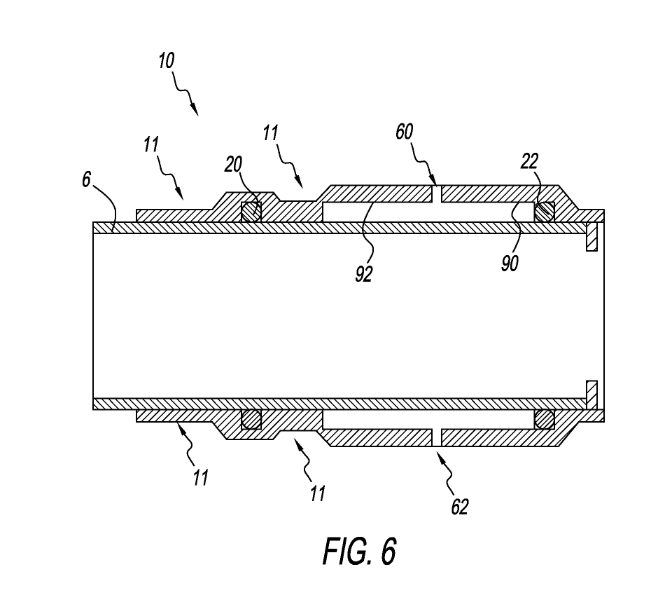

FIG. 6 shows a cross-sectional view of a crimp fitting embodiment of the pipe connector 10 having a piping section 6 inserted within. The pipe connector 10 includes a connection means having a surface 11 configured to crimp into a piping section when pressed by tool. In a preferred crimp fitting embodiment, at least one O-ring is configured to crimp into a piping section and at least one O-ring is configured to receive a sealant. As FIG. 6 shows, the pipe connector 10 has an interior diameter along an axial surface 92 to correspond to an exterior diameter of a pipe or fitting. A second axial surface 60 includes a diameter formed to create a space or cavity between the pipe or fitting section and the second axial surface 90. The diameter of the second axial surface 90 is preferably greater than the diameter associated with the axial surface 92. In this way, a user may inject sealant through the opening 60 and into a cavity space as described herein above. The cavity space is positioned within the pipe connector 10 to include an O-ring 22, leaving at least one O-ring such as O-ring 20 without a cavity space for sealant injections.

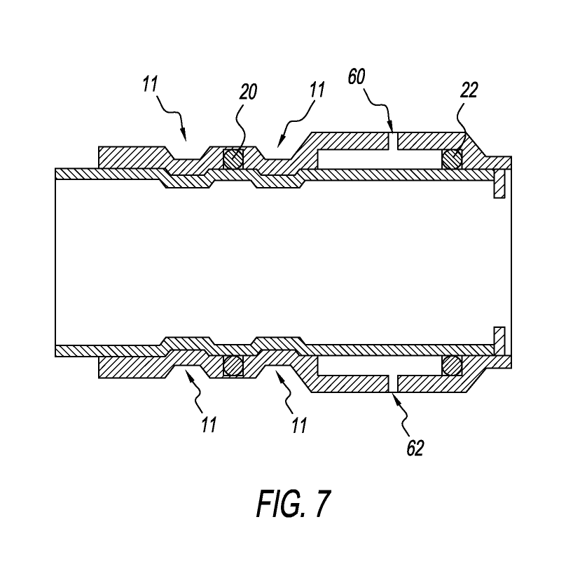

FIG. 7 shows a cross-sectional view of an embodiment of the pipe connector 10 depicted in FIG. 6 with the connection means engaging a pipe. As FIG. 7 shows, the surfaces 11 are crimped into the piping section 6, securing the piping section 6 within the pipe connector 10. One skilled in the art will readily recognize that the pipe connector 10 as depicted in FIGS. 6 and 7 may additionally include multiple additional O-rings including both crimping connection means and sealant connection means.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus, comprising:
a housing comprising a first and second inlets for receiving a piping section, the first and second inlets formed by an interior axial surface having a first diameter;
a pipe engaging means;
a first and a second aperture formed by the housing; and
an axially recessed portion formed by an interior axial surface having a second diameter greater than the first diameter, wherein the first and second apertures open into an interior region of the apparatus associated with the axially recessed portion.

2. The apparatus of claim 1, wherein the pipe engaging means comprises a crimping portion of the housing configured to press against an inserted piping section.

3. The apparatus of claim 2, wherein the crimping portion corresponds to housing portions proximate to the first O-ring.

4. The apparatus of claim 1, wherein the axially recessed portion is configured to receive a first O-ring and a second O-ring is internally disposed within a recess of the housing separate from the axially recessed portion.

5. The apparatus of claim 1, further comprising: a moveable collar.

6. The apparatus of claim 1, further comprising: a pipe stop integrally formed with the housing.

7. The apparatus of claim 1, wherein the axially recessed portion is sized to receive a sealant.

8. The apparatus of claim 1, wherein the pipe engaging means comprises an integrally formed push-fit connection assembly comprising a teeth ring having a plurality of teeth.

9. The apparatus of claim 1, wherein the first aperture is disposed 180-degrees from the second aperture.

10. The apparatus of claim 1, wherein the axially recessed portion abuts a second axially recessed portion configured to receive an O-ring.

11. An apparatus, comprising:
a housing comprising a first and second inlets for receiving a piping section, the first and second inlets formed by an interior axial surface having a first diameter;
a push-fit connection assembly comprising a teeth ring having a plurality of teeth configured to engage the piping section;
a first and a second aperture formed by the housing;
a first O-ring internally disposed within a first axially recessed portion of the housing;
a second O-ring internally disposed within a second axially recessed portion of the housing; and
a third axially recessed portion formed by an interior axial surface having a second diameter greater than the first diameter, wherein the third axially recessed portion forms a sidewall of the first and second axially recessed portions, and wherein the first and second apertures open into an interior region of the apparatus associated with the axially recessed portion.

12. The apparatus of claim 11, further comprising: a moveable collar.

13. The apparatus of claim 11, further comprising: a pipe stop integrally formed with the housing.

14. The apparatus of claim 11, wherein the second axially recessed portion is sized to receive a sealant.

15. The apparatus of claim 11, wherein the first aperture is disposed 180-degrees from the second aperture.

16. An apparatus, comprising:
a housing comprising a first and second inlets for receiving a piping section, the first and second inlets formed by an interior axial surface having a first diameter;
a pipe engaging means comprising a crimping portion of the housing configured to press against an inserted piping section;
a first and a second aperture formed by the housing; and
a first O-ring internally disposed within a first axially recessed portion of the housing;
a second O-ring internally disposed within a second axially recessed portion of the housing; and
a third axially recessed portion formed by an interior axial surface having a second diameter greater than the first diameter, wherein the third axially recessed portion forms a void space with the second axially recessed portion, and wherein the first and second apertures open into an interior region of the apparatus associated with the axially recessed portion.

17. The apparatus of claim 16, wherein second and third axially recessed portions are formed by an interior axial surface having a same diameter.

18. The apparatus of claim 16, wherein the first axially recessed portion is separated from the second axially recessed portion.

19. The apparatus of claim 16, wherein the crimping portion corresponds to housing portions proximate to the first O-ring.

20. The apparatus of claim 16, wherein the second axially recessed portion is sized to receive a sealant.
